(19) United States
(12) Patent Application Publication
(10) Pub. No.: US 2015/0262179 A1
(43) Pub. Date: Sep. 17, 2015

(54) PAYING METHOD AND SYSTEM BY USING NETWORK

(71) Applicant: SHEN ZHEN CIFPAY NETWORK BANK TECHNOLOGY CO., LTD, Shenzhen, Guangdong (CN)

(72) Inventor: Yi Zhang, Guangdong (CN)

(73) Assignee: SHENZHEN CIFPAY NETWORK BANK TECHNOLOGY CO., LTD, Shenzhen (CN)

(21) Appl. No.: 14/424,486

(22) PCT Filed: Mar. 18, 2013
(86) PCT No.: PCT/CN2013/072793

§ 371 Date: Feb. 27, 2015

(51) Int. Cl. G06Q 20/40; G06Q 20/38; G06Q 20/10

(52) U.S. Cl. CPC G06Q 20/405; G06Q 20/108; G06Q 20/3825

(57) ABSTRACT

The present invention provides a network payment method and system. The network payment method used in a network payment system comprising a first-type bank server, a first-type client terminal, a second-type bank server, a second-type client terminal, a logistics server, and a network payment server, the method comprises the steps of: the first-type client terminal sends application information to the network payment server so as to apply for an information packet for promise of payment; the network payment server generates a temporary information packet for promise of payment based on the application information, and sends the temporary information packet to the first-type bank server; the first-type bank server receives the temporary information packet, and authenticates it; and if the authentication is successful, the first-type bank server generates an information packet for promise of payment, freezes funds, and sends the information for the freezing to the second-type bank server.

### FIELD OF THE INVENTION

The present invention relates to the technical field of electronic commerce, particularly to a method and system for network payment.

### BACKGROUND

E-commerce has been increasingly and widely used in various commercial and trade activities. The so-called e-commerce refers to a business and trade pattern of commercial and trade activities, which achieves online shopping of consumers, online transactions between merchants and online electronic payments and a variety of business activities, trading activities, financial activities and related comprehensive service activities, based on browser and server applications, in the open network environment of Internet.

Currently, the credit bottleneck in the checkout process of online electronic payment (network payment) is always an obstacle to the development of e-commerce (network trading). Within current online electronic payment modes, the solutions that the guarantee is issued by a third-party payment company are less risky. However, with the guarantee issued by a third-party payment company, the payer client (payer) would have paid its funds to the third-party payment company without the receipt of goods, and once the third-party payment company has a problem, the funds of payer client will not be guaranteed. Therefore, the funding risk for a payer client is still relatively high with guarantees issued by third-party payment companies.

### SUMMARY

The object of the present invention is to provide a network payment method and system configured to solve the problem that the capital risk for a payer client is relatively high in existing network payment.

The present invention is achieved as follows. A network payment method used in a network payment system comprising a first-type bank server, a first-type client terminal, a second-type bank server, a second-type client terminal, a logistics server, and a network payment server, the network payment method comprises the steps of: the first-type client terminal sends application information to the network payment server so as to apply for an information packet for promise of payment; the network payment server generates a temporary information packet for promise of payment based on the application information sent by the first-type client terminal, and sends the temporary information packet for promise of payment to the first-type bank server; the first-type bank server receives the temporary information packet for promise of payment sent by the network payment server, and authenticates the temporary information packet for promise of payment; and if the authentication is successful, the first-type bank server generates an information packet for promise of payment according to the temporary information packet for promise of payment, freezes funds, and sends the information for the freezing of the funds to the second-type bank server.

Preferably, the network payment method further comprises: the second-type bank server receives the information for the freezing of the funds sent by the first-type bank server, and sends the information for the freezing of the funds to the second-type client terminal; and the second-type client terminal generates information for being available for delivery after receiving the information for the freezing of the funds sent by the second-type bank server, and sends the information for being available for delivery to the logistics server.

Preferably, the network payment method further comprises: after receiving the information for being available for delivery sent by the second-type client terminal, the logistics server conducts the operation of delivery, and sends the delivery information to the network payment server.

Preferably, the network payment method further comprises: after receiving the delivery information sent by the logistics server, the network payment server sends the delivery information to the first-type bank server.

Preferably, the delivery information includes a tracking number.

Preferably, the network payment method further comprises: after goods have been received and signed, the logistics server sends the information for receipt and signature to the network payment server.

Preferably, the information for receipt and signature includes time of receipt and information regarding whether the goods were received and signed by the addressee or others.

Preferably, the network payment method further comprises: after receiving the information for receipt and signature sent by the logistics server, the network payment server sends the information for receipt and signature to the first-type bank server.

Preferably, the network payment method further comprises the following steps: after receiving the information for receipt and signature, the first-type bank server sends information for the key of payment request to the network payment server; the network payment server saves the information for the key of payment request, and sends the information for the key of payment request to the second-type client terminal; the second-type client terminal receives the information for the key of payment request sent by the network payment server, and sends the information for the key of payment request to the second-type bank server; and according to the information for the key of payment request, the second-type bank server generates information for payment request and sends the information for payment request to the first-type bank server.

Preferably, the information for payment request includes the information for the key of payment request.

Preferably, the network payment method further comprises: the first-type bank server receives the information for payment request sent by the second-type bank server, and verifies the accuracy of the information for the key of payment request of the information for payment request, if the verification indicates the key information is correct, then makes a payment to the payer's bank and feeds back payment information to the second-type bank server.

Preferably, the application information includes: information regarding the payer's bank, payment amount and payment currency.

Preferably, the first-type client terminal is to send the application information to the network payment server according to the instructions from the payer client.

Preferably, the key of payment request is a password to unfreeze the funds.

The present invention also provides a network payment system comprises: a first-type bank server, a first-type client terminal, a second-type bank server, a second-type client terminal, a logistics server and a network payment server, wherein: the first-type client terminal, which is for a payer client and connected to the first-type bank server, the logistics server and the network payment server, and according to the instructions from the payer client, sends application information to the network payment server in order to apply for an information packet for promise of payment; the network payment server, which is connected to the first-type client terminal, the first-type bank server, the second-type client terminal and the logistics server, based on the application information sent by the first-type client terminal, generates a temporary information packet for promise of payment, and sends the information packet for promise of payment to the first-type bank server; the first-type bank server, which is for a payer's bank and connected to the first-type client terminal, the second-type bank server and the network payment server, after receiving the temporary information packet for promise of payment sent by the network payment server, authenticates the temporary information packet for promise of payment, if the authentication is successful, then the first-type bank server generates an information packet for promise of payment based on the temporary information packet for promise of payment, freezes funds, and sends the information for the freezing of the funds to the second-type bank server; the second-type bank server, which is for a payee's bank and connected to the first-type bank server and the second-type client terminal, receives the information for the freezing of the funds sent by the first-type bank server, and sends the information for the freezing of the funds to the second-type client terminal; the second-type client terminal, which is for a payee client and connected to the second-type bank server, the logistics server and the network payment server, generates information for being available for delivery after receiving the information for the freezing of the funds sent by the second-type bank server, and sends the information for being available for delivery to the logistics server so as to request to deliver the goods; and the logistics server, which is for logistics enterprise and connected to the first-type client terminal, the second-type client terminal and the network payment server, after receiving the information for being available for delivery sent by the second-type client terminal, conducts the operation of delivery, and sends the delivery information to the network payment server.

Preferably, the network payment server, after receiving the information for receipt and signature sent by the logistics server, sends the information for receipt and signature to the first-type bank server, and after receiving the information for the key of payment request sent by the first-type bank server, saves the information for the key of payment request, and sends the information for the key of payment request to the second-type client terminal.

Preferably, the key of payment request is a password to unfreeze the funds.

Preferably, after receiving the information for the key of payment request sent by the network payment server, the second-type client terminal sends the information for the key of payment request to the second-type bank server.

Preferably, after receiving the information for the key of payment request sent by the second-type client terminal, the second-type bank server generates information for payment request, sends the information for payment request to the first-type bank server, and makes a payment to the payee client after receiving the payment information sent by the first-type bank server.

Preferably, after receiving the information for receipt and signature, the first-type bank server sends the information for the key of payment request to the network payment server, and after receiving the information for payment request sent by the second-type bank server, makes a payment to the payer's bank, and feeds back the payment information to the second-type bank server.

Preferably, after the payer client has received and signed the goods, the logistics server sends the information for receipt and signature to the network payment server and the second-type client terminal.

Preferably, the application information includes: information regarding the payer's bank, payment amount and payment currency.

For payer clients, the network payment method or system of the present invention freezes funds first, rather than pays out the funds directly, and hence it reduces financial risk, and protects the interests of the payer clients.

### BRIEF DESCRIPTION OF THE DRAWINGS

In order to illustrate the technical solutions of the embodiments of the present invention or prior arts more clearly, the drawings used for the description of the embodiments or the prior arts will be briefly introduced as follows. Obviously, the drawings in the following descriptions are merely some examples of the present invention, and one of ordinary skill in the art can also derive other drawings from these drawings without any creative efforts.

FIG. 1 is a schematic view of the network payment system provided by an embodiment of the invention;

FIG. 2A and FIG. 2B is a flowchart of the network payment method provided by an embodiment of the present invention.

### DETAILED DESCRIPTION

To make the objects, technical solutions and advantages of the present invention more clearly, the present invention will be described in further details with reference to the drawings and the embodiments as follows. It should be understood that the specific examples described herein are merely for explaining the present invention and are not intended to limit the present invention.

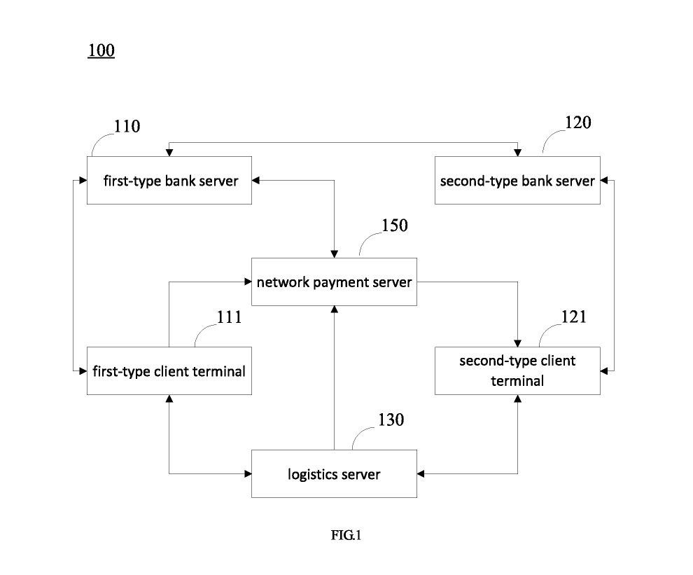

Please refer to FIG. 1. FIG. 1 is a block diagram of a network payment system 100 provided by an embodiment of the present invention. As shown in FIG. 1, network payment system 100 includes a first-type bank server 110, a first-type client terminal 111, a second-type bank server 120, a second-type of client terminals 121, a logistics server 130, and a network payment server 150.

The first-type client terminal 111, which is suitable for a payer client, is connected to the first-type bank server 110, the logistics server 130 and the network payment server 150. When the payer determines to purchase some commodities, the first-type client terminal 111 sends application information to the network payment server 150 so as to apply for an information packet for promise of payment, wherein, the application information includes: information regarding the payer's bank, payment amount and payment currency.

The network payment server 150 is connected to the first-type client terminal 111, the first-type bank server 110, the second-type client terminal 121 and the logistics server 130, generates a temporary information packet for promise of payment according to the application information sent by the first-type client terminal 111, and sends the temporary information packet for promise of payment to the first-type bank server 110. The network payment server 150, after receiving the information for receipt and signature sent by the logistics server 130, sends the information for receipt and signature to the first-type bank server 110, and after receiving the information for the key of payment request sent by the first-type bank server 110, saves the information for the key of payment request, and sends the information for the key of payment request to the second-type client terminal 121. Wherein, the key of payment request is a password to unfreeze the funds.

The first-type bank server 110, which is suitable for to a payer's bank, is connected to the first-type client terminal 111, the second-type bank server 120 and the network server 150. After receiving the temporary information packet for promise of payment sent by the network payment server 150, the first-type bank server 110 authenticates the temporary information packet for promise of payment. If the authentication is successful (which means that the temporary information packet for promise of payment is valid), then authorization is successful, and the first-type bank server 110 according to the temporary information packet for promise of payment generates an information packet for promise of payment, freezes funds, and sends the information for the freezing of the funds to the second-type bank server 120; and if the authorization fails (which means that the temporary information packet for promise of payment is invalid), then the first-type bank server 110 feeds back a reject message to the first-type client terminal 111 and the network payment server 150. After receiving the information for receipt and signature, the first-type bank server 110 sends the information for the key of payment request to the network payment server 150, and after receiving the information for payment request sent by the second-type bank server 120, the first-type bank server 110 makes a payment to the payer's bank and feeds back the information for the accomplished payment to the second-type bank server 120.

The second-type client terminal 121, which is suitable for a payee terminal, is connected to the second-type bank server 120, the logistics server 130 and the network server 150. The second-type client terminal 121 generates information for being available for delivery after receiving the information for the freezing of the funds sent by the second-type bank server 120, and sends the information for being available for delivery to the logistics server 130 to apply shipments; and after receiving the information for the key of payment request sent by the network payment server 150, the second-type client terminal 121 sends the information for the key of payment request to the second-type bank server 120.

The second-type bank server 120, which is suitable for the payee's bank, is connected to the first-type bank server 110 and the second-type client terminal 121. The second-type bank server 120 receives the information for the freezing of the funds sent by the first-type bank server 110, and sends the information for the freezing of the funds to the second-type client terminal 121. After receiving the information for the key of payment request sent by the second-type client terminal 121, the second-type bank server 120 generates information for payment request and sends the information for payment request to the first-type bank server 110, and makes a payment to the payee client after receiving the information for the accomplished payment sent by the first-type bank server 110.

The logistics server 130, which is suitable for logistics companies, is connected to the first-type client terminal 111, the second-type client terminal 121 and the network payment server 150. After receiving the information for being available for delivery sent by the second-type client terminal 121, the logistics server 130 conducts the operation of delivery, and sends the information for the accomplished delivery to the network payment server 150. After the payer client has received and signed the goods, the logistics server 130 sends the information for receipt and signature to the network payment server 150 and the second-type client terminal 121.

Through the above description of the embodiment shown in FIG. 1, those skilled in the art should be aware that, the first-type client terminal 111 and the second-type client terminal 121 may be integrated in the same client device, such as mobile phones, computers, PDAs or POS terminals; similarly, the first-type bank server 110 and the second-type bank server 120 may also be integrated in the same device for bank client; and the payer's bank and the payee's bank may be the same bank.

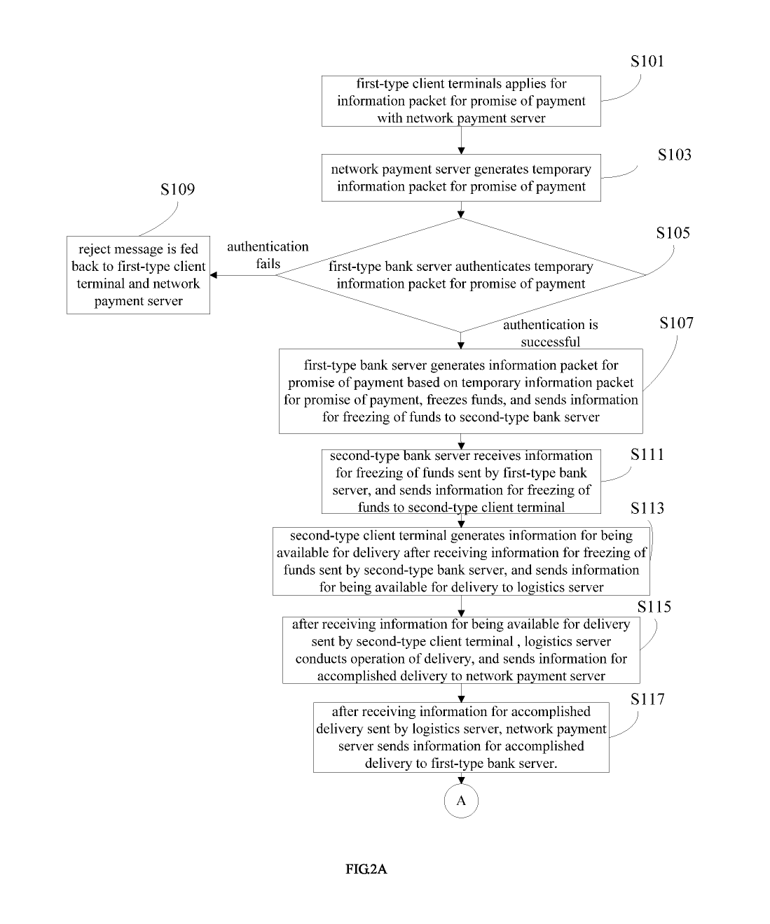

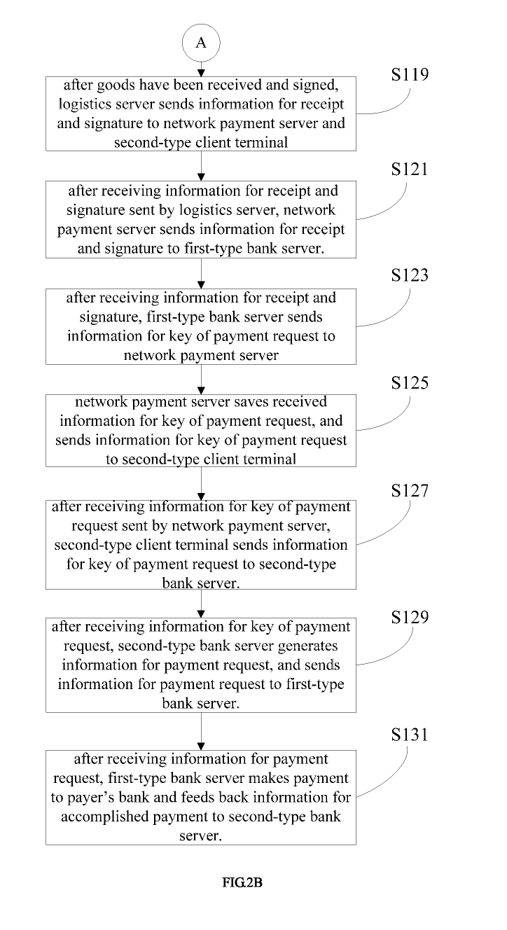

FIG. 2A and FIG. 2B is a flowchart of the network payment method according to an embodiment of the present invention. As shown in FIG. 1, the network payment method provided by the present invention comprises the steps of:

Step S101: the first-type client terminals 111 applies for an information packet for promise of payment with the network payment server 150, i.e., according to the instructions from the payer client, the first-type client terminal 111 sends application information to the network payment server 150 in order to apply for an information packet for promise of payment. Wherein, the application information includes: information regarding the payer's bank, payment amount and payment currency.

Step S103: the network payment server 150 generates a temporary information packet for promise of payment, i.e., based on the application information sent by the first-type client terminal 111, the network payment server 150 generates a temporary information packet for promise of payment, and sends the information packet for promise of payment to the first-type bank server 110.

Step S105: the first-type bank server 110 authenticates the temporary information packet for promise of payment, i.e., after receiving the temporary information packet for promise of payment sent by the network payment server 150, the first-type bank server 110 authenticates the temporary information packet for promise of payment, and if the authentication is successful (which means that the temporary information packet for promise of payment is valid), then Step S107 is proceeded, and if the authentication fails (which means that the temporary information packet for promise of payment is invalid), then Step S109 is proceeded.

Step S107: the first-type bank server 110 generates an information packet for promise of payment based on the temporary information packet for promise of payment, freezes funds, and sends the information for the freezing of the funds to the second-type bank server 120.

Step S109: a reject message is fed back to the first-type client terminal 111 and the network payment server 150.

Step S111: the second-type bank server 120 receives the information for the freezing of the funds sent by the first-type bank server 110, and sends the information for the freezing of the funds to the second-type client terminal 121;

Step S113: the second-type client terminal 121 generates information for being available for delivery after receiving the information for the freezing of the funds sent by the second-type bank server 120, and sends the information for being available for delivery to the logistics server 130.

Step S115: after receiving the information for being available for delivery sent by the second-type client terminal 121, the logistics server 130 conducts the operation of delivery, and sends the information for the accomplished delivery to the network payment server 150.

Step S117: after receiving the information for the accomplished delivery sent by the logistics server 130, the network payment server 150 sends the information for the accomplished delivery to the first-type bank server 110. Wherein, the information for the accomplished delivery includes a tracking number.

Step S119: after goods have been received and signed, the logistics server 130 sends the information for receipt and signature to the network payment server 150 and the second-type client terminal 121, wherein, the information for receipt and signature includes the details of the receipt, such as, the time of the receipt, whether the goods were received and signed by the addressee or others, etc.

Step S121: after receiving the information for receipt and signature sent by the logistics server 130, the network payment server 150 sends the information for receipt and signature to the first-type bank server 110.

Step S123: after receiving the information for receipt and signature, the first-type bank server 110 sends information for the key of payment request to the network payment server 150, wherein the payment request means a request for releasing the freeze of the funds, and the information for the key of the payment request is a password to unfreeze the funds.

Step S125: the network payment server 150 saves the received information for the key of payment request, and sends the information for the key of payment request to the second-type client terminal 121.

Step S127: after receiving the information for the key of payment request sent by the network payment server 150, the second-type client terminal 121 sends the information for the key of payment request to the second-type bank server 120.

Step S129: after receiving the information for the key of payment request sent by the second-type client terminal 121, according to the information for the key of payment request, the second-type bank server 120 generates information for payment request, and sends the information for payment request to the first-type bank server 110, wherein the information for payment request includes the information for the key of payment request.

Step S131: after receiving the information for payment request sent by the second-type bank server 120, the first-type bank server 110 makes a payment to the payer's bank and feeds back the information for the accomplished payment to the second-type bank server 120. After receiving the information for payment request, the first-type bank server 110 verifies the accuracy of the information for the key of payment request of the information for payment request, only if the verification indicates the information for the key of payment request is correct, then the server 110 conducts the operation of payment.

After receiving the funds, the payer's bank transfers the funds to an account of the payee client. Then the entire online payment process is completed.

For payer clients, the network payment method or system of the present invention freezes funds first, rather than pays out the funds directly, and hence it reduces financial risk, and protects the interests of the payer clients. In addition, by use of the network payment method and system according to the present invention, without the confirmation for the receipt of goods by payer clients, payee clients may receive funds only if logistics enterprise send back the information of receipt and signature, and hence it reduces financial risk of payees, and protects the interests of the payee clients.

The above description is only preferred embodiments of the present invention, it is not intended to limit the present invention, any modifications, equivalents, and improvements, etc., made within the spirit and principles of the present invention, should be included in the protection scope of the present invention.

1. A network payment method used in a network payment system comprising a first-type bank server, a first-type client terminal, a second-type bank server, a second-type client terminal, a logistics server, and a network payment server,
the network payment method comprises the steps of:
the first-type client terminal sends application information to the network payment server so as to apply for an information packet for promise of payment;
the network payment server generates a temporary information packet for promise of payment based on the application information sent by the first-type client terminal, and sends the temporary information packet for promise of payment to the first-type bank server;
the first-type bank server receives the temporary information packet for promise of payment sent by the network payment server, and authenticates the temporary information packet for promise of payment; and
if the authentication is successful, the first-type bank server generates an information packet for promise of payment according to the temporary information packet for promise of payment, freezes funds, and sends the information for the freezing of the funds to the second-type bank server.

2. The network payment method as recited in claim 1, wherein the network payment method further comprising the steps of:
the second-type bank server receives the information for the freezing of the funds sent by the first-type bank server, and sends the information for the freezing of the funds to the second-type client terminal; and
the second-type client terminal generates information for being available for delivery after receiving the information for the freezing of the funds sent by the second-type bank server, and sends the information for being available for delivery to the logistics server.

3. The network payment method as recited in claim 2, wherein the network payment method further comprising:
after receiving the information for being available for delivery sent by the second-type client terminal, the logistics server conducts the operation of delivery, and sends the information for the accomplished delivery to the network payment server.

4. The network payment method as recited in claim 3, wherein the network payment method further comprising:
after receiving the information for the accomplished delivery sent by the logistics server, the network payment server sends the information for the accomplished delivery to the first-type bank server.

5. The network payment method as recited in claim 4, wherein the information for the accomplished delivery includes a tracking number.

6. The network payment method as recited in claim 4, wherein the network payment method further comprising:
after goods have been received and signed, the logistics server sends the information for receipt and signature to the network payment server.

7. The network payment method as recited in claim 6, wherein the information for receipt and signature includes time of receipt and information regarding whether the goods were received and signed by the addressee or others.

8. The network payment method as recited in claim 6, wherein the network payment method further comprising:
after receiving the information for receipt and signature sent by the logistics server, the network payment server sends the information for receipt and signature to the first-type bank server.

9. The network payment method as recited in claim 8, wherein the network payment method further comprising the steps of:
after receiving the information for receipt and signature, the first-type bank server sends information for the key of payment request to the network payment server;
the network payment server saves the information for the key of payment request, and sends the information for the key of payment request to the second-type client terminal;
the second-type client terminal receives the information for the key of payment request sent by the network payment server, and sends the information for the key of payment request to the second-type bank server; and
according to the information for the key of payment request, the second-type bank server generates information for payment request and sends the information for payment request to the first-type bank server.

10. The network payment method as recited in claim 9, wherein the information for payment request includes the information for the key of payment request.

11. A network payment method as recited in claim 10, wherein the network payment method further comprising:
the first-type bank server receives the information for payment request sent by the second-type bank server, and verifies the accuracy of the information for the key of payment request of the information for payment request, if the verification indicates the key information is correct, then makes a payment to a payer's bank and feeds back information for the accomplished payment to the second-type bank server.

12. The network payment method as recited in claim 1, wherein the application information includes: information regarding the payer's bank, payment amount and payment currency.

13. The network payment method as recited in claim 1, wherein the first-type client terminal is to send the application information to the network payment server according to the instructions from the payer client.

14. The network payment method as recited in claim 9, wherein the key of payment request is a password to unfreeze the funds.

15. A network payment system comprising: a first-type bank server, a first-type client terminal, a second-type bank server, a second-type client terminal, a logistics server and a network payment server, wherein:
the first-type client terminal, which is for a payer client and connected to the first-type bank server, the logistics server and the network payment server, and according to the instructions from the payer client, sends application information to the network payment server in order to apply for an information packet for promise of payment;
the network payment server, which is connected to the first-type client terminal, the first-type bank server, the second-type client terminal and the logistics server, based on the application information sent by the first-type client terminal, generates a temporary information packet for promise of payment, and sends the information packet for promise of payment to the first-type bank server;
the first-type bank server, which is for a payer's bank and connected to the first-type client terminal, the second-type bank server and the network payment server, after receiving the temporary information packet for promise of payment sent by the network payment server, authenticates the temporary information packet for promise of payment, if the authentication is successful, then the first-type bank server generates an information packet for promise of payment based on the temporary information packet for promise of payment, freezes funds, and sends the information for the freezing of the funds to the second-type bank server;
the second-type bank server, which is for a payee's bank and connected to the first-type bank server and the second-type client terminal, receives the information for the freezing of the funds sent by the first-type bank server, and sends the information for the freezing of the funds to the second-type client terminal;
the second-type client terminal, which is for a payee client and connected to the second-type bank server, the logistics server and the network payment server, generates information for being available for delivery after receiving the information for the freezing of the funds sent by the second-type bank server, and sends the information for being available for delivery to the logistics server so as to request to deliver the goods; and
the logistics server, which is for logistics enterprise and connected to the first-type client terminal, the second-type client terminal and the network payment server, after receiving the information for being available for delivery sent by the second-type client terminal, conducts the operation of delivery, and sends the information for the accomplished delivery to the network payment server.

16. The network payment system as recited in claim 15, wherein the network payment server, after receiving the information for receipt and signature sent by the logistics server, sends the information for receipt and signature to the first-type bank server, and after receiving the information for the key of payment request sent by the first-type bank server, saves the information for the key of payment request, and sends the information for the key of payment request to the second-type client terminal.

17. The network payment system as recited in claim 16, wherein the key of payment request is a password to unfreeze the funds.

18. The network payment system as recited in claim 17, wherein, after receiving the information for the key of payment request sent by the network payment server, the second-type client terminal sends the information for the key of payment request to the second-type bank server.

19. The network payment system as recited in claim 18, wherein, after receiving the information for the key of payment request sent by the second-type client terminal, the second-type bank server generates information for payment request, sends the information for payment request to the first-type bank server, and makes a payment to the payee client after receiving the information for the accomplished payment sent by the first-type bank server.

20. The network payment system as recited in claim 19, wherein, after receiving the information for receipt and signature, the first-type bank server sends the information for the key of payment request to the network payment server, and after receiving the information for payment request sent by the second-type bank server, makes a payment to the payer's bank and feeds back the information for the accomplished payment to the second-type bank server.

21. The network payment system as recited in claim 20, wherein, after the payer client has received and signed the goods, the logistics server sends the information for receipt and signature to the network payment server and the second-type client terminal.

22. The network payment system as recited in claim 15, wherein, the application information includes: information regarding the payer's bank, payment amount and payment currency.
